(19) United States
(12) Patent Application Publication
(10) Pub. No.: US 2012/0176528 A1
(43) Pub. Date: Jul. 12, 2012

(54) METHOD FOR DETERMINING THE SHARPNESS OF A FIXED-FOCUS CAMERA, TEST DEVICE FOR TESTING THE SHARPNESS OF A FIXED-FOCUS CAMERA, FIXED-FOCUS CAMERA AS WELL AS METHOD FOR ASSEMBLING A FIXED-FOCUS CAMERA

(75) Inventors: Patrick Eogham Denny, Galway (IE); Pat Lyons, Moylough County (IE)

(73) Assignee: Connaught Electronics Limited, Tuam, County Galway (IE)

(21) Appl. No.: 13/391,636

(22) PCT Filed: Aug. 31, 2009
(86) PCT No.: PCT/EP2009/006286

§ 371 Date: Mar. 14, 2012

(51) Int. Cl. H04N 5/232

(52) U.S. Cl. 348/345; 348/E05.045

(57) ABSTRACT

The invention relates to a method for determining the validity of a measured sharpness of a fixed-focus camera (8), in which a first image of an object (13) is captured by the camera (8) and the sharpness of the image is determined, wherein an additional first optical element (15, 15′) is introduced into the optical path of the camera (8) and a second image of the object (13) is captured and the sharpness of the second image is determined, wherein depending on the comparison of the sharpnesses of at least the two images, the presence of an imaging error of the camera (8) is identified. The invention also relates to a device for testing the sharpness of a fixed-focus camera, a fixed-focus camera as well as the use of a test device for a fixed-focus camera in a vehicle and a method for assembling a fixed-focus camera.

The invention relates to a method for determining the sharpness of a fixed-focus camera. Furthermore, the invention relates to a test device for testing the sharpness of a fixed-focus camera as well as a fixed-focus camera. Moreover, the invention relates to a method for assembling a fixed-focus camera.

Fixed-focus cameras have a fixed focus, thus an invariant adjustment of distance. Such cameras are for example employed in vehicles and are known there for environmental detection or for detection of passengers as well. Information about the environment captured by such cameras is provided to driver assistance systems. Moreover, depending on information of passengers or at least body parts of passengers captured by the cameras, similarly, driver assistance systems can operate or security systems such as airbags or the like can be operated. In particular, in this connection, there can be detected the position of body parts or the fatigue of a driver for example based on a capture of a blink. Depending on that, warnings or interventions in the drivability of the vehicle can be affected or, if applicable, upon triggering an airbag, the ignition and the inflation of the airbag can be affected depending on the detected position of a vehicle passenger.

In order to be able to ensure sufficient functionality, the fixed position between the lens and the imager of the camera has to be adjusted relatively exactly. Thus, it is therefore required that a corresponding test is performed before fundamental installation of the camera in the vehicle. Similarly, after a certain operation time, such a test can also be affected by determining if the camera has altered due to assembly errors or various influences in operation and the sharpness no longer corresponds to the desired sharpness.

From GB 1,167,240, a device for measuring, for controlling and/or for adjusting the position of the optimum image plane of a photographic or cinematographic objective employed in a camera in auto-collimation with the aid of a reflector is known. The reflector is disposed displaceable in the direction of the optical axis of the capturing objective.

It is the object of the present invention to provide a method for determining the image capture characteristic of a fixed-focus camera, a test device for testing the sharpness of a fixed-focus camera, a fixed-focus camera and a method for assembling a fixed-focus camera, by which the image capture characteristics can be determined in precise and low-effort manner and can be adjusted as needed.

This object is solved by a method having the features of claim 1, a test device having the features according to claim 11 and a method having the features according to claim 13. Moreover, this object is also solved by a camera by claim 12.

In the method according to the invention for determining a sharpness of a fixed-focus camera, a first image of an object is captured by the camera and the sharpness of the image is determined. An additional first optical element is inserted into the optical path of the camera and a second image of the object is captured. The sharpness of the second image is determined, wherein the presence of an imaging error of the camera is identified depending on the comparison of the sharpnesses of at least the two images. Thus, a test method is provided, which allows incorrect image capture characteristic of a fixed-focus camera in low-effort and precise manner.

In particular, the fixed-focus camera is sensitive in the spectral range visible to the human.

Preferably, it is provided that the camera has a camera lens, which has a sharpness curve with a sharpness maximum or focus score maximum characteristic of the camera lens depending on the distance of the camera lens to an image capturing unit of the camera. Depending on the comparison of the sharpnesses of at least the two images, it is identified on which side of the sharpness maximum the focus score of the first image is located on the sharpness curve. Thus, based on the comparison, it can be determined, which image capture characteristic the camera has at the time of test. In this connection, the first optical element additionally inserted into the optical path of the camera is not to be considered as associated with the camera. It is only inserted into the optical path in the test method in capturing the second image.

Preferably, depending on the position of the first focus score on the sharpness curve relative to the sharpness maximum, it is identified, which type of imaging error of the camera is present. Based on simple approaches and with minimum expenditure of components, thus, an undesired lack of focus of the camera can be identified very precisely, wherein a specific present imaging error of the camera can even then be identified similarly in simple, yet reliable manner.

Preferably, as a type of an imaging error, short-sightedness or long-sightedness of the camera is identified. Especially this identification of these specific imaging errors is very important since, especially with fixed-focus cameras, a variation of the distance between the camera lens and the image capturing unit due to assembly accuracies or due to environmental influences in operation, therefore can vary this fixed-focus in undesired manner, and from this, the mentioned specific imaging errors result. Since the camera then captures images optionally in unusable manner or in a manner, which is not suitable especially with regard to the utilization and consideration in the functionality of driver assistance systems or results in errors of the system, the identification of these specific imaging errors is of particular importance.

Preferably, a convex lens, in particular a bi-convex lens, is inserted on the side of the camera lens facing away from the image capturing unit as the first optical element, and short-sightedness of the camera is identified if the focus score of the second image is smaller than the focus score of the first image. Upon such insertion of a specific optical element of the camera, long-sightedness is identified if the focus score of the second image is greater than the focus score of the first image. By inserting a single additional optical element into the optical path virtually only in a second step and by capturing a second image, by the comparisons of the focus scores and the specific sharpness curve of the camera lens, a distinct identification of the short-sightedness or of the long-sightedness can already be allowed. It can also be provided that a concave lens, in particular a bi-concave lens, is inserted on the side of the camera lens facing away from the image capturing unit as the first optical element, and short-sightedness of the camera is identified if the focus score of the second image is greater than the focus score of the first image. Moreover, by such a further specific element in the form of a concave lens, in particular a bi-concave lens, long-sightedness of the camera can be identified if the focus score of the second image is smaller than the focus score of the first image.

Thus, two specific lens shapings can contribute to be able to identify the type of the imaging errors in simple and precise manner. Compared to simple reflectors, lenses are optical elements influencing the passing light in a very specific manner. Due to this characteristic and the knowledge of the characteristic of this light deflection, they allow clear statements about the type of the possible imaging errors of the camera in connection with the sharpness curve of the camera lens.

Preferably, it can be provided that the distance of an additionally inserted optical element to the camera lens is varied and, depending thereon, the variation of the focus score is detected. Especially if only one optical element is inserted into the optical path in a subsequent step for capturing the first image, and only by the comparison of the first image with the second image produced then, a statement about the image capture characteristic of the camera is to be performed, by such a relative positional variation of the optical element to the camera lens and thus also to the image capturing unit, a corresponding statement about the type of the imaging error can be allowed in connection with the sharpness curve.

Particularly advantageously, it is provided that, especially after capturing the second image, the first optical element is removed, a second optical element different from the first optical element with respect to the direction of light is inserted into the optical path of the camera, and a third image of the object is captured and the sharpness of the third image is determined. Depending on the comparison of the sharpnesses of at least the three images, an existence of an imaging error of the camera is identified. With this approach for testing the image characteristic of the camera, thus, in three steps, a first image is captured without an additional optical element in the optical path of the camera, in a second step, a first optical element is inserted into the optical path and a second image of the object is captured, and subsequently, after removing the first optical element, a different second optical element is inserted into the optical path, and a third image of the object is captured. Thereby, the precision of the statement about the existence of an imaging error and moreover about the concrete type of the imaging error, can be specified over again. Especially, this is particularly important if due to a sharpness curve characteristic of the camera lens, in the region of the sharpness maximum, first, relatively flat curve slopes are present, and upon only relatively slight disadjustment of the camera and thus a relatively slight deviation from the sharpness maximum, yet a precise statement about a possible imaging error of the camera is to be ensured. Since especially with such flat curve progresses in the region of the sharpness maximum, lacks of focus optionally present are relatively hard to identify, by the approach with at least three images and insertion of two different optical elements in consecutive method steps, the precision of statement can be substantially increased.

Preferably, a convex, in particular bi-convex lens is inserted as one of the optical elements, in particular the first optical element, and a concave, in particular bi-concave lens is inserted as the other optical element, in particular the second optical element.

In particular, in case of consecutive use of two different optical elements and the capture of at least three images, short-sightedness of the camera is identified if the focus scores of the first image and of the third image are greater than the focus score of the second image, and long-sightedness of the camera is identified if the focus scores of the first image and of the second image are greater than the focus score of the third image.

When focusing a camera, a lens is suspended between an imager and a target. The lens is moved in space until it is determined by the optimality of an image sharpness measure that the camera is most favourably focussed. Without loss of generality, such a focus score can be a cumulative score determined from contributions from separate regions of interest in an image, in order to provide a generally good image. Typically, the focus score is based on tests similar to ISO12233:2000 MTF50 measures, which reflect the camera systems ability to reproduce sharp contrast changes in the object space on the imager.

The ambiguity is because a score does not uniquely associate with a mechanical distance between imager and lens. If a lens is brought from a great distance towards an imager, the image sharpness measures gradually increase, until they reach a peak (when the target appears maximally sharp to the camera) and as the camera lens-to-imager-distance is further reduced, the score drops again. This means that even though an image quality measure can be expressed as a function of imager-lens distance, the function does not have an inverse in the range containing the distance within which the camera is in focus.

Thus a measurement of a score that is expected at a fixed temperature is not an indicator that the camera is actually correctly configured. It may be the case that the camera is in fact wrongly configured.

In summary for design verification, production and customers return quality control and diagnostic purposes, once a score is measured, it needs to be understood which side of the curve peak the camera lens-to-imager score represents.

An example of this is that a score may represent a camera that is suboptimal at a nominal low measurement temperature, but will improve as the temperature increases and give a good general performance over the temperature range, or, it may represent a camera whose performance is suboptimal at a nominal low measurement temperature and which will get worse over the automotive temperature range.

This issue can be addressed in a novel way by the use of a dioptre. A dioptre is a lens that is combined with another lens to create a compound lens with a new effective focal length.

When this optimal lens to imager location is found, an additional change (offset) can be made to the camera lens-to-imager distance so that the natural elastic thermal variation of the lens to imager distance over the automotive temperature range (increases with temperature) gives the best overall sharpness over temperature in the application and/or because the intention is that the camera should primarily be focussed on a region of interest at a different target distance in the application than in the tester.

However, an offset can also occur on a camera that has been put through subsequent processes or environmental conditions whose effect has not yet been characterised. In particular, heating a camera typically increases the distance between the camera lens and the imager and conversely cooling the camera decreases the distance, all the time changing the focus score.

Such offsets can create an ambiguity during the subsequent inspection of cameras as they got through production or subsequently and this is the fundamental issue that we want to address.

For each lens there is a characteristic curve which can be used to indicate for an image sharpness measure the best focus.

For our purposes the focal length of the new compound lens is modelled as a function of the focal lengths of the camera lens, dioptre and most importantly of the distance d between them according to following Equation:

$$Back Focal Length ( BFL ) of Camera \text{-} Dioptre system = \frac{{f}_{Dioptre} \cdot ( d - {f}_{Camera} )}{d - ( {f}_{Dioptre} - {f}_{Camera} )}$$

One can determine on which side of the curve the camera system is on by varying the camera lens-dioptre distance d, monitoring focus score during the variation of d and establishing from behaviour of focus score versus d with the characteristic curve.

Preferably, this operation should be possible using a concave and a convex dioptre lens to allow us to change the back focal length so that we can traverse the maximum focus score, allowing us to also characterize the maximum possible for a give lens. Using two dioptres improves the accuracy of the results and also allows traversal of the maximum focus score. Using only one dioptre would lead to ambiguous results for a camera that is aligned near the top of the characterization curve, as the curve is flatter here and tolerances on results may cause ambiguity.

As outlined, the purpose of such a dioptre system is to check cameras at final function test or subsequently during quality checks and debugging, or during prototyping, in order to establish which side of the focus characterization curve a camera lens is aligned and in other words, to check if the camera is short sighted or long sighted. The preferred embodiment of a testing device has to have two dioptre lenses that can be alternatively moved in and out from the front of the camera lens during the function test in the test dives.

One dioptre lens would be convex and the other concave. This would correspondingly change the sign of f_{Dioptre} in Equation, while otherwise preserving the dependence of the back focal lens on the distance d.

Assuming that the dioptre will be located about 1.5 cm above the camera lens, if the camera being tested is aligned on the right hand side of the characterization curve, this means that its lens is too close to the imager and the camera is longsighted.

In this case, placing the convex dioptre in front of the camera will increase its focus score while the concave dioptre lens will reduce the focus score.

Conversely, it the camera being tested is aligned on the left hand side of the characterization curve, this means that its lens is too far from the imager and the camera is short-sighted. In this case, placing the convex dioptre in front of the camera will decrease the focus score while the concave dioptre will increase the focus score.

Where a camera is aligned in a linear part of the curve, it is calculated that the dioptres will increase or decrease its focus score by about 10%.

Only the centre focus score is to be measured when the dioptres are in place.

When not being used, the dioptres must be parked in a location that will not obstruct any parts of the target from the camera under test. Similarly, the mechanism for moving the dioptres must not obstruct the camera's view of the target for the normal Production Tester tests.

Only one additional optical element, a concave or concave lens, is brought into the optical path of the camera when a second image of the object is captured. Further only one additional optical element, a concave or convex lens, is brought into the optical path of the camera when a third image of the object is captured.

The separation between the top surface of the camera lens and the bottom surface of the dioptre lens should be preferably 15 mm+/−1 mm. The convex dioptre lens should have preferably a strength of +3.5 (focal length=28.6 cm). The concave dioptre lens should have preferably a strength of −3.5 (focal length=28.6 cm). The diameter of each dioptre lens should be 65 mm+/−5 mm. Both dioptre lenses preferably are manufactured with the same type of optical glass.

Furthermore, the invention relates to a test device for testing the sharpness of a fixed-focus camera, which has a camera lens and an image capturing unit and at least one additional optical element, which can be positioned in the optical path of the camera on the side of the camera lens facing away from the image capturing unit in specific test phases. Furthermore, the test device includes an evaluating unit, wherein for testing the sharpness, a first image of an object is captured by the camera without the optical element, and subsequently, a second image of the object is captured by the camera with the optical element, and the evaluating unit is formed such that the sharpness of the at least two images can be determined and an existence of an imaging error of the camera can be identified depending on a comparison of the sharpness.

Preferably, it is provided that the test device includes an additional first and an additional second optical element. They each can be individually inserted into the optical path of the camera in specific consecutive test phases. With the second optical element, a third image of the object then is also captured, and the three images are evaluated to the effect that if an imaging error of the camera exists.

Further advantageous embodiments of the method according to the invention for determining the sharpness of the fixed-focus camera are to be considered as advantageous implementations of the test device.

Furthermore, the invention relates to a method for assembling a fixed-focus camera, in which upon assembly of the camera components, a distance between a camera lens and an image capturing unit is adjusted such that on the environmental conditions, in particular the temperature, the sharpness of the camera deviates in defined manner from the sharpness required at least in one operational phase in the field of the camera upon assembly, and due to the environmental conditions existing, in particular the temperature, in at least one operational phase the distance between the camera lens and the image capturing unit automatically varies such that the sharpness of the camera is within a tolerance interval about a sharpness maximum in this operational phase. Especially if a camera is exposed to extreme temperature conditions in its field, due to thermal expansions of camera components, in particular the case, variations of the distance between the camera lens and the imager can arise. In particular, it is provided that the camera is disposed on or in a vehicle in the field in operation and the environmental conditions encompass a temperature interval between −40° C. and +105° C. in operational phases.

In particular, if the assembly of the camera is effected at normal ambient temperature, approximately between +20° C. and +30° C., considerable deviations from that can occur in the field in the vehicle, and thereby, the lacks of focus can be induced. By the approach according to the invention in assembling the fixed-focus camera, exactly this is avoided such that in particular across the entire temperature interval possible in the field in certain operational phases, the variation of distance between the camera lens and the image capturing unit maximally is effected such that the sharpness is not smaller than a presettable threshold value. Preferably, the tolerance interval of a range of values is formed around the sharpness maximum by +/−15% of the sharpness maximum, in particular +/−10%. Thus, in assembly, such a distance is deliberately adjusted, which is still provided with a tolerable lack of focus of the camera.

Further the invention concerns to a fixed-focus camera mountable on or in a motor vehicle, in particular a camera for environmental detection of a motor vehicle, comprising a camera lens and an image capturing unit spaced to the camera lens. A distance between said camera lens and said image capturing unit is adjusted such that the sharpness of the camera deviates in defined manner from the sharpness required in at least one operational phase in the field of the camera on the environmental conditions, in particular the temperature, upon assembly, and due to the environmental conditions, in particular the temperature, existing in the at least one operational phase the distance automatically varies such that a sharpness of the camera is within a tolerance interval around a sharpness maximum.

Therefore preferably a defined image error of the camera is adjusted in a defined manner when assembling the camera. So when assembling the camera the very precise unsharpness of the camera is adjusted such that a very good sharpness is automatically achieved during operation conditions of the camera over a wide range of this conditions.

Furthermore, the invention relates to the use of a test device according to the invention for a sharpness test of a fixed-focus camera mountable on or in a motor vehicle, in particular a camera for environmental detection of a motor vehicle. Such cameras are constructed in particularly compact manner and minimized in components, since they are to operate inexpensively and yet highly precise. For employment of the motor vehicles, therefore, only a few types of cameras specified with regard to function and size are possible. Especially also with regard to the attachment to vehicle components minimized in installation space and yet stable on the one hand and the robustness with respect to greatly varying environmental conditions, only a very specific configuration of a camera allows the employment on or in a motor vehicle.

On the other hand, however, since such cameras have to ensure precise image capture on all of these specific environmental conditions, the specific test based on the above mentioned explanation is particularly essential. The captured images have to allow a very exact statement about the situation on different environmental conditions, since they are taken as decision criteria for the functionality of driver assistance systems or other security facilities in the vehicle and therefore have to satisfy highest safety aspects. Therefore, a false activity of a driver assistance system or of another security facility on the vehicle due to insufficient images is unacceptable.

Further features of the invention appear from the claims, the figures and the description of figures. The features and feature combinations mentioned above in the description as well as the features and feature combinations mentioned below in the description of figures and/or shown in the figures alone are usable not only in the respectively indicated combination, but also in other combinations and alone without departing from the scope of the invention.

Below, embodiments of the invention are explained in more detail based on schematic drawings. There show:

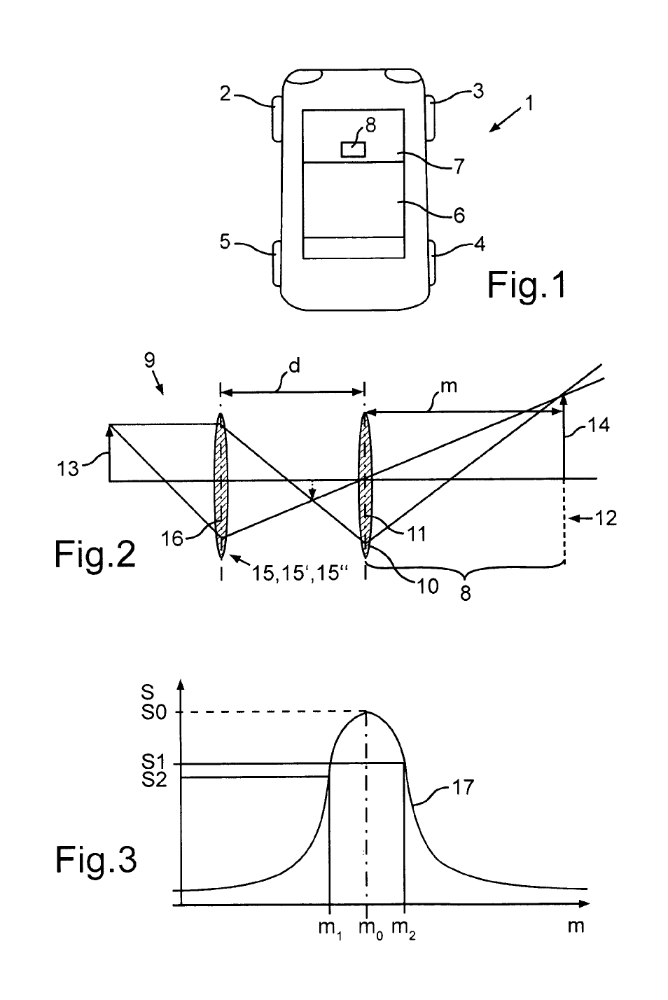

FIG. 1 a schematic representation of a vehicle with at least one camera;

FIG. 2 a schematic representation of a test device in a specific test stage; and

FIG. 3 a schematic diagram, in which an exemplary sharpness curve of a camera lens in the camera is shown.

In the figures, similar or functionally equivalent elements are provided with the same reference characters.

In FIG. 1, in a schematic top view, a vehicle 1 is shown, which is a passenger car. The vehicle 1 includes four wheels 2, 3, 4 and 5 and a passenger compartment delimited to the top by a roof 6. Moreover, the vehicle 1 includes a windshield 7. A camera 8 is disposed on it merely exemplarily. However, the camera 8 can also be disposed at any other location, for example also on the roof liner on the roof 6. The camera 8 is constructed for viewing and detecting in the environment outside of the vehicle 1, wherein the images detected by the camera 8 are the basis for the functionality and decision support for one or more driver assistance systems of the vehicle 1. However, the camera 8 can also be formed for capturing images in the passenger compartment and thus in the interior of the vehicle. For example, photographs of body parts of a vehicle passenger, in particular of the vehicle driver, can be taken here too.

The camera 8 is constructed relatively compact and minimized in installation space and is realized with components as few as possible. In particular, the camera 8 includes a camera lens 10 (FIG. 2) and an image capturing unit 12. In the field on or in the vehicle 1, the camera 8 is subjected to very different environmental conditions, and in particular temperatures of −40° C. to 60° C. can occur. In particular within this temperature interval, it is required that the camera 8 captures images of the environment and thus also of objects 13 (FIG. 2) as sharp as possible.

The camera 8 is a fixed-focus camera such that it has a fundamentally fixedly adjusted focus. The distance m is measured between the centre plane 11 of the camera lens 10 and the imager, in particular an image capturing type of the image capturing unit 12. This fixedly preset distance m can vary due to the above mentioned conditions or basically be formed deviating from it such that lack of focus can occur upon image capture in this respect.

Depending on its shaping and its material configuration, the camera lens 10 has a specific sharpness curve 17 (FIG. 3). This sharpness curve 17 indicates the focus score S depending on the distance m to the imager of the image capturing unit 12 as information. A sharpness maximum S0 upon image capture is achieved with the camera 8 if a reference distance m0 is adjusted. If the actual distance m between the centre plane 11 and the imager deviates from this reference distance m0, thus, lack of focus occurs and the image capture deteriorates. This is indicated by the sharpness curve 17.

Due to the temperature influences in the field on the vehicle 1, in particular by the above mentioned temperature interval, distance variations can occur by material expansion and shrinking. In FIG. 3, therein, a distance m1 decreased based on the reference distance m0 is shown exemplarily, which appears at maximum cold temperature below the zero point, wherein a focus score S2 results thereby. Analagously, on very hot environmental conditions, an expansion can appear to the effect that the distance increases based on the reference distance m0 and maximum distance m2 appears, in which a focus score S1 then results. However, the focus scores S1, S2 are smaller than the sharpness maximum S0.

Therefore, the camera 8 is to be tested for possible lacks of focus in this respect, wherein it can be performed both before the actual delivery and the installation in the vehicle 1 and after a certain period of operation in the vehicle 1.

For this, a test device 9 is provided. The camera 8 is inserted into the test device 9 and a first image of an object 13 is captured. Subsequently, then, a first optical element 15 separate from the camera lens 10 and camera 8 is introduced into the optical path between the object 13 and the camera 8. In the embodiment, this first optical element 15 is a bi-convex lens. This first optical element 15 is disposed in a distance d, measured between a centre plane 16 of the optical element 15 and the centre plane 11 of the camera lens 10, between the object 13 and the camera lens 10. After this first optical element 15 is inserted, then, a second image of the object 13 is captured, but wherein a captured image unitarily provided with the reference character 14 is respectively captured on the imager. Thus, a second image of the object 13 is captured with the camera 8 with the first optical element 15 in the optical path.

In particular, it is provided that the distance d between the first optical element 15 and the camera lens 10 is varied such that the variation of the focus score S thereby can be detected upon image capture, and depending on the variation of the focus score, it can be identified if the distance m between the camera lens 10 and the imager of the image capturing unit 12 is equal to the reference distance m0 or if it is smaller or greater than it. By comparison of the focus scores of the first image and the second image, then it can be determined if an imaging error of the camera 8 exists, and moreover, the type of the imaging error of the camera 8 can even be identified. This is effected in that short-sightedness of the camera 8 is identified as imaging error with the bi-convex lens if the focus score of the second image is smaller than the focus score of the first image. Correspondingly, long-sightedness of the camera 8 can be identified if the focus score of the second image is greater than the focus score of the first image.

However, instead of a bi-convex lens, a bi-concave lens can also be disposed in corresponding position as the first optical element, and here too, in particular the distance d can be varied. Even with such a different first optical element 15′, an imaging error and also the type of the imaging error can be identified. This is affected in that short-sightedness of the camera 8 is identified if the focus score of the second image is greater than the focus score of the first image, wherein long-sightedness of the camera 8 is identified if the focus score of the second image is smaller than the focus score of the first image.

In a particularly preferred implementation it is provided that the test device 9 has a second optical element 15″, which preferably is a bi-concave lens, besides a first optical element, which preferably is a bi-convex lens. Both lenses can be inserted into the optical path and again be removed from it like already in the previously explained embodiment. In utilization of optical elements 15 and 15″, in the approach for determining an imaging error and moreover the type of the imaging error, it is provided that an image of the object 13 is taken without presence of an optical element 15 or 15″, respectively, on the one hand. Afterwards, a second image of the object 13 is then captured when only the first optical element 15 is inserted in the optical path. Moreover, a third image of the object 13 is captured when only the second optical element 15″ is disposed in the optical path. Thus, three images of the object 13 are captured, wherein the order of the capture of the three images can be arbitrary.

It is advantageous with such an approach with the capture of at least three images that the precision of the statement to the effect that which type of the imaging error exists is increased. In particular if the variation of distance between the camera lens 10 and the imager is relatively low with respect to the reference distance m0 and thus the variation is near the sharpness maximum S0, the statements about the type of the imaging error can be substantially specified in this respect.

In particular, in an embodiment it is provided that only the central focus score of an image and thus in particular on the optical axis for the evaluation if and, if applicable, which imaging error exists, are taken into account.

This focus score F0_{A} measured in the centre without one of the optical elements 15 and 15′ as well as this central focus score F0_{B} of the first optical element 15′ according to the bi-convex lens and the central focus score F0_{C} of the second optical element 15″ according to the bi-concave lens are compared to each other, thus statements result from it, on which side of the sharpness curve 17 the focus score is located with respect to the sharpness maximum S0, and the type of imaging error can be determined. Thus, if upon first measurement a first image is captured without the optical elements 15′, 15″, in a subsequent step a second image is captured with the bi-convex lens in the optical path and in a subsequent third step a third image with the bi-concave lens in the optical path is captured, the actual focus score of the camera 8 is on the right side of the curve with respect to the sharpness maximum S0 if the focus scores F0_{B} and F0_{A} are greater than the focus score F0_{C}. This means that the camera lens 10 is closer to the imager than the reference distance m0 and the camera exhibits long-sightedness. On the other hand, the actual focus score of the camera 8 with respect to the sharpness maximum S0 is on the left side of the sharpness curve 17 if the focus score F0_{C} and the focus score F0_{A} are greater than the focus score F0_{B}. If it is identified that the focus score S is on the left side of the sharpness curve 17 with respect to the sharpness maximum S0, thus, it means that the distance between the camera lens 10 and the imager is greater than the reference distance m0 and the camera 8 exhibits short-sightedness.

Preferably, it is provided that a distance between the front side of the camera lens 10 and the optical elements 15 and 15′ formed as the dioptre lens, respectively, in particular the backside thereof, is 15 mm+/−1 mm. Preferably, the convex dioptre lens, which is the bi-convex lens, has a refractive power of +3.5, and the concave dioptre lens, which is the bi-concave lens according to the second optical element, has a refractive power of −3.5. Preferably, the diameter of the dioptre lenses is 65 mm+/−5 mm.

If it is determined according to the above explained embodiment upon capture of the three images that the focus score F0_{A} is greater than the focus scores F0_{B} and F0_{C} and the focus scores F0_{B} and F0_{C} are equal, the sharpness maximum is present and the reference distance m0 is also present. Preferably, the determined focus scores are stored.

Before the camera 8 is disposed in the vehicle 1, the individual components are to be assembled and thus the camera 8 is to be mounted. Since the environmental conditions are also specific in this assembly as the environmental conditions in the field in the vehicle 1 and they optionally deviate, it is provided that the assembly is effected in the field with regard to optimum sharpness. For this, it is provided that the fixed-focus camera 8 is assembled such that a distance between the camera lens 10 and an image capturing unit 12 is adjusted in defined manner such that the sharpness of the camera 8 deviates in defined manner from the sharpness required in at least one operational phase in the field of the camera 8, namely in the vehicle 1, on the environmental conditions, in particular the temperature, upon assembly, and the distance automatically varies due to the environmental conditions existing in the at least one operational phase, in particular the temperature, such that a sharpness of the camera 8 is within a tolerance interval about the sharpness maximum SO. This means that upon assembly, the camera 8 is deliberately assembled in the non-optimum state with respect to the sharpness, but this is effected in defined manner such that with regard to the known environmental conditions in the field, the distance variation between the camera lens 10 and the image capturing unit 12 is automatically effected such that the sharpness is improved in the field at least in some operational phases. In particular, the tolerance interval is formed in a range of values of +/−15%, in particular +/−10% of the sharpness maximum around this sharpness maximum.

1. A method for determining a sharpness of a fixed-focus camera, the method comprising:
capturing a first image of an object by the camera;
determining a sharpness of the first image;
introducing first optical element, separate from the camera, into an optical path of the camera;
capturing a second image of the object;
determining a sharpness of the second image; and,
identifying presence of an imaging error of the camera depending on a comparison of the sharpness of the first and second images.

2. The method according to claim 1, wherein the camera has a camera lens, which has a characteristic sharpness curve with a sharpness maximum, wherein said sharpness curve comprises focus scores depending on a distance of the camera lens to an image capturing unit of the camera, wherein the method further comprises
identifying, depending on the comparison of the sharpness of the first and second images, on which side of the sharpness maximum the focus score of the first image is located.

3. The method according to claim 2, further comprising:
identifying, depending on a position of the focus score of the first image relative to the sharpness maximum which type of imaging error of the camera is present.

4. The method according to claim 3, wherein the type of imaging error comprises one selected from a group consisting of short-sightedness or long-sightedness of the camera.

5. The method according to claim 4, wherein the first optical element is a bi-convex lens that is inserted the first optical element on a side of the camera lens facing away from the image capturing unit, and wherein short-sightedness of the camera is identified if a focus score of the second image is smaller than the focus score of the first image, and longsightedness of the camera is identified if the focus score of the second image is greater than the focus score of the first image.

6. The method according to claim 4, wherein the first optical element is a bi-concave lens that is introduced on a side of the camera lens facing away from the image capturing unit, and wherein short-sightedness of the camera is identified if a focus score of the second image is greater than the focus score of the first image, and long-sightedness of the camera is identified if the focus score of the second image is smaller than the focus score of the first image.

7. The method according to claim 1, wherein a distance of an additionally introduced optical element to the camera lens is varied, and wherein variation of the focus score is detected based on the varied distance.

8. The method according to claim 4, wherein the a second optical element, different from the first optical element with respect to a direction of light and separate from the camera, is introduced into the optical path of the camera, and wherein a third image of the object is captured and a sharpness of the third image is determined, wherein presence of an imaging error of the camera is identified based on a comparison of the sharpness of the first, second, and third images.

9. The method according to claim 8, wherein a bi-convex lens is introduced as the first optical element, and a biconcave lens is introduced as the second optical element.

10. The method according to claim 8, wherein short-sightedness of the camera is identified if focus scores of the first and the third images are greater than the focus score of the second image, and longsightedness of the camera is identified if the focus scores of the first and the second images are greater than the focus score of the third image.

11. A test device for testing a sharpness of a fixed-focus camera, the camera comprising a camera lens, an image capturing unit, and at least one optical element separate from the camera and positioned in an optical path of the camera on a side of the camera lens facing away from the image capturing unit, the test device comprising:
an evaluating unit, wherein
a first image of an object is captured by the camera without the at least one optical element and a second image of the object is captured by the camera with the at least one optical element, and
the evaluating unit is is configured to determine: a sharpness of the first and second images, and presence of an imaging error of the camera depending on a comparison of the sharpness of the first and second images.

12. A fixed-focus camera mountable on or in a motor vehicle for environmental detection of the motor vehicle, comprising:
a camera lens; and
an image capturing unit spaced from the camera lens,
wherein, upon assembly of the camera, a distance between said camera lens and said image capturing unit is adjusted such that a sharpness of the camera deviates in a defined manner from a sharpness required in at least one operational phase in the field of the camera with respect to temperature conditions, upon assembly, and wherein, due to temperature conditions existing in the at least one operational phase, the distance automatically varies such that a sharpness of the camera is within a tolerance interval of a sharpness maximum.

13. A method for assembling a fixed-focus camera, comprising:
adjusting, upon assembly of camera components, a distance between a camera lens and an image capturing unit such that a sharpness of the camera deviates in a defined manner from a sharpness required in at least one operational phase in the field of the camera with respect to temperature conditions, upon assembly, and due to temperature conditions existing in the at least one operational phase the distance automatically varies such that a sharpness of the camera is within a tolerance interval of a sharpness maximum.

14. The method according to claim 13, in which the camera is disposed on or in a motor vehicle in operation and the temperature conditions encompass a temperature interval between minus 400 C and plus 1050 C in operation.

15. The method according to claim 13, wherein the tolerance interval encompasses a range of values ±10% of the sharpness maximum.
